(19) United States
(12) Patent Application Publication
(10) Pub. No.: US 2025/0021458 A1
(43) Pub. Date: Jan. 16, 2025

(54) METHOD FOR MONITORING ELECTRONIC DEVICES

(71) Applicants: Yung-Chien WANG, Taoyuan City (TW); Kuo-Chu HU, Taoyuan City (TW); Szu-Hsin YEH, Taoyuan City (TW); Chi-Wen HUNG, Taoyuan City (TW)

(72) Inventors: Yung-Chien WANG, Taoyuan City (TW); Kuo-Chu HU, Taoyuan City (TW); Szu-Hsin YEH, Taoyuan City (TW); Chi-Wen HUNG, Taoyuan City (TW)

(21) Appl. No.: 18/219,720

(22) Filed: Jul. 10, 2023

(51) Int. Cl. G06F 11/32; G06F 11/30; G06K 7/14

(52) U.S. Cl. CPC G06F 11/328; G06F 11/3006; G06K 7/1417

(57) ABSTRACT

The electronic device monitoring method, provided by the present invention, comprises the following steps: obtaining a coordinate information and an additional information of each electronic device by the master electronic device; generating a display position table by the master electronic device according to the coordinate information and the additional information of each electronic device; generating a barcode pattern, indicating a monitoring website and a plurality of display parameters, by the master electronic device according to the display position table in real time; reading the barcode pattern by a mobile device to connect to a browsing interface related to the monitoring website associated with a monitoring website address; displaying a device pattern corresponding to each electronic device by the browsing interface according to a plurality of display parameters; wherein the barcode pattern indicates the monitoring website address and the plurality of display parameters.

### BACKGROUND OF THE INVENTION

### Cross Reference to Related Application

### 1. FIELD OF THE INVENTION

The present invention relates to a method for monitoring electronic devices, particularly to a method for remote operation of electronic devices.

### 2. Description of the Prior Art

Traditionally, a monitoring computer is often used to control and manage all electronic devices, and the electronic devices and the monitoring computer are usually placed in the same room. The advantage is that engineers can directly observe each electronic device, making it easier to control the correct electronic device. Additionally, engineers can instantly see its status of each electronic device while performing various operations. In other words, the traditional method for monitoring electronic devices requires engineers to stay with using the monitoring computer, which not only is more intuitive but also helps prevent mistakes. However, if the electronic devices need to be operated for a long period, keeping engineers on-site is evidently inefficient.

Currently, some electronic devices can be connected wirelessly, allowing engineers to operate remotely. In practice, to ensure the correct electronic device is wirelessly connected, engineers still need to be on-site while establishing the connection to the electronic device. Once the connection to the correct electronic device is confirmed, engineers can then leave the site to perform remote operations. However, when engineers need to switch to different electronic devices, they still need to return to the site and reconnect with another electronic device, making the connection to electronic devices less convenient. Therefore, there is a need in the industry for a new method of monitoring electronic devices that not only enables remote control of electronic devices but also allows engineers to operate and use them more intuitively.

### SUMMARY OF THE INVENTION

The present invention provides a method for monitoring electronic devices by providing a barcode pattern, allowing engineers to obtain relevant information of all connectable electronic devices at once. Furthermore, the relevant information of all connectable electronic devices is displayed in a browsing interface, enabling engineers to operate and use them more intuitively.

The present invention proposes a electronic device monitoring method for monitoring a plurality of electronic devices installed in a cabinet, where the electronic devices are defined to have a master electronic device and at least one slave electronic device. The electronic device monitoring method comprises the following steps: obtaining a coordinate information and an additional information of each electronic device by the master electronic device; generating a display position table by the master electronic device according to the coordinate information and the additional information of each electronic device; generating a barcode pattern, indicating a monitoring website and a plurality of display parameters, by the master electronic device according to the display position table in real time; reading the barcode pattern by a mobile device to connect to a browsing interface related to the monitoring website associated with a monitoring website address; displaying a device pattern corresponding to each electronic device by the browsing interface according to a plurality of display parameters; wherein the barcode pattern indicates the monitoring website address and the plurality of display parameters.

In some embodiments, the coordinate information of each electronic device records either a physical position order of each electronic device in the cabinet or a wiring order of each electronic device in the cabinet. Besides, the additional information of each electronic device records a network address of each electronic device. In addition, the browsing interface connects to each electronic device based on the network address of each electronic device to obtain a plurality of device patterns corresponding to the electronic devices. Moreover, the device pattern of each electronic device is displayed in the browsing interface in an arrangement order corresponding to the physical position order or the wiring order.

In some embodiments, in the step of obtaining the coordinate information and the additional information of each electronic device by the master electronic device may comprise the following steps: broadcasting a positioning request by the master electronic device; and feedbacking, by each slave electronic device, the coordinate information and the additional information to the master electronic device based on the positioning request.

In some embodiments, each device pattern displayed in the browsing interface may be linked to a network address corresponding to the electronic device associated with the device pattern. When selecting one of the device patterns in the browsing interface, the electronic device corresponding to the device pattern may be remotely connected. In the step of remotely connecting to the electronic device corresponding to the device pattern may comprise the following steps: obtaining a status information of the electronic device corresponding to the device pattern; and displaying the status information in the browsing interface. Besides, the browsing interface may further receive an operation command to control the electronic device corresponding to the selected device pattern.

In summary, the electronic device monitoring method provided by the present invention allows the master electronic device to establish a display position table and convert it into a barcode pattern. Engineers can conveniently obtain relevant information of all connectable electronic devices at once by scanning the barcode pattern. Additionally, the electronic device monitoring method provided by the present invention can simultaneously display multiple device patterns associated with multiple electronic devices in one browsing interface. Since each device pattern mimics the appearance of the electronic device and the relative positions of the device patterns in the browsing interface correspond to the positions of the electronic devices in reality, engineers can intuitively operate and use them in the browsing interface.

### BRIEF DESCRIPTION OF THE APPTERMINALED DRAWINGS

FIG. 1 illustrates a block diagram of a test system applied an electronic device monitoring method according to an embodiment of the present invention.

FIG. 2 illustrates a schematic diagram of the electronic device monitoring method applied in a browsing interface according to an embodiment of the present invention.

FIG. 3 illustrates a schematic diagram of the electronic device monitoring method applied in a browsing interface according to another embodiment of the present invention.

FIG. 4 shows a flowchart of the electronic device monitoring method according to an embodiment of the present invention.

### DETAILED DESCRIPTION OF THE INVENTION

The features, targeting, and functions of the present invention are further disclosed below. However, it is only a few of the possible embodiments of the present invention, and the scope of the present invention is not limited thereto; that is, the equivalent changes and modifications done in accordance with the claims of the present invention will remain the subject of the present invention. Without departing from the spirit and scope of the invention, it should be considered as further enablement of the invention.

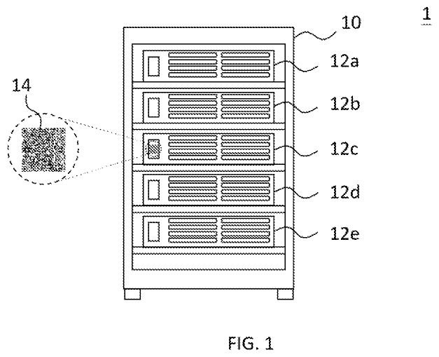

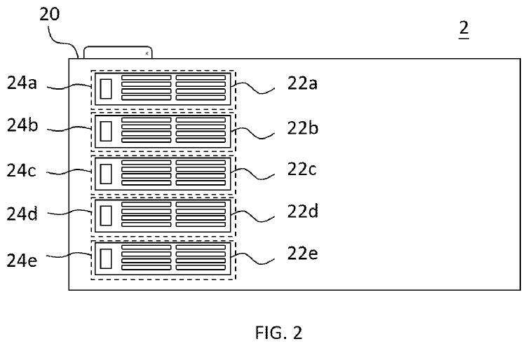

Please refer to both FIG. 1 and FIG. 2, FIG. 1 illustrates a block diagram of a test system applied an electronic device monitoring method according to an embodiment of the present invention, FIG. 2 illustrates a schematic diagram of the electronic device monitoring method applied in a browsing interface according to an embodiment of the present invention. As shown in the figures, the electronic device monitoring method of the present invention can be applied in a test system 1, which may have a cabinet 10 and multiple electronic devices 12a˜12e. The cabinet 10 can be a housing or shelf used to install/store the electronic devices 12a˜12e, which can be various machines used for electrical testing, such as voltage suppliers, current suppliers, or instruments for detecting voltage or current. Additionally, although FIG. 1 shows one cabinet 10 and five electronic devices 12a˜12e installed within the cabinet 10, the embodiments of the present invention do not limit the number of cabinets 10 or the number of electronic devices that can be contained within each cabinet 10. Furthermore, the electronic devices 12a˜12e are stacked in the cabinet 10, as demonstrated in FIG. 1, which is for illustrative purposes and not limited in this embodiment. For example, the electronic devices 12a˜12e could also be placed horizontally adjacent to each other within the cabinet 10 for illustration purposes.

In one embodiment, numbers corresponded to the electronic devices 12a˜12e in cabinet 10 can be given are in a fixed sequence. These sequential numbers are determined based on the physical position order of electronic devices 12a˜12e in cabinet 10, with the top to bottom being referred to as the first to fifth electronic device, respectively. In another embodiment, the wiring order of electronic devices 12a˜12e in cabinet 10 may differ from the physical position order. For example, suppose the electronic device 12a is wired to electronic device 12e, and then electronic device 12e is wired to electronic device 12c. In this case, the wiring order of electronic device 12e is after electronic device 12a, and the sequential number of electronic device 12c is after electronic device 12e. For better illustration, we assume that the physical position order and the wiring order of electronic devices 12a˜12e in cabinet 10 are the same.

The electronic devices 12a˜12e, besides being capable of conducting electrical tests individually, should also possess networking capabilities. For instance, each electronic device 12a˜12e can connect to the network either wired or wirelessly and can be assigned a unique identifiable network address (e.g. IP address). Among the electronic devices 12a˜12e, any one can be designated as a master electronic device, while the other four are considered slave electronic devices. In this embodiment, the electronic device 12c is assumed to be the master electronic device, with the electronic devices 12a, 12b, 12d, and 12e being the slave electronic devices. In an example, the electronic devices 12a˜12e know their sequential numbers in either the physical position order or the wiring order beforehand. This embodiment does not limit how the electronic devices 12a˜12e obtain their sequential numbers. For instance, engineers can assign the sequential numbers to each of the electronic devices, or the electronic devices 12a˜12e can individually execute a positioning process to determine their sequential numbers based on the physical position order or the wiring order. In this embodiment, the sequential numbers of the electronic devices 12a˜12e in the physical position order or wiring order are defined as a coordinate information. It is worth mentioning that this embodiment does not constrain the format of the sequential numbers corresponding to the physical position order or the wiring order; the sequential numbers should be able to indicate the electronic devices 12a˜12e in sequence.

Furthermore, the electronic devices 12a˜12e can store an additional information besides the coordinate information. In practice, this additional information could indicate its model, its network address, or its functions, with no specific limitations in this embodiment. Besides, the electronic device 12c (the master electronic device) can obtain the coordinate information and the additional information of each electronic device. Specifically, in addition to its own coordinate information and additional information should be known by the electronic device 12c, the electronic device 12c actively broadcasts a positioning request to other connected electronic devices. As this embodiment assumes that the electronic devices 12a˜12e in the cabinet 10 are connected by wires, the aforementioned other connected electronic devices refer to the slave electronic devices (the electronic devices 12a, 12b, 12d, 12e) apart from the master electronic device. Upon receiving the positioning request, the slave electronic devices will feedback their own coordinate information and the additional information to the master electronic device (the electronic device 12c). Consequently, the master electronic device can record the coordinate information and additional information of all electronic devices 12a˜12e. In an example, the master electronic device can periodically broadcast the positioning request to actively determine whether the connected electronic devices have increased or decreased. Alternatively, whenever there is a change in the connected electronic devices, at least one slave electronic device will automatically notify the master electronic device to trigger its broadcasting of the positioning request. Additionally, engineers can connect to the master electronic device to manually trigger its broadcasting of the positioning request, with no specific limitations ‘in this embodiment.

Next, the master electronic device generates a display position table based on the recorded coordinate information and the recorded additional information. The display position table may contain not only the coordinate information and the additional information but also other data. For instance, the display position table demonstrated in this embodiment could record the physical position order or the wiring order of each electronic device in cabinet 10, as well as the network addresses of each electronic device. In one example, the master electronic device generates a barcode pattern 14 in real-time based on the content of the display position table. It's worth noting that whenever there is a change in the content of the display position table maintained by the master electronic device, the master electronic device can promptly update the barcode pattern 14. For example, if a new electronic device is added to the cabinet 10 and is connected to the master electronic device, the master electronic device will modify the display position table accordingly and generate a new corresponding barcode pattern 14.

In order to remotely control the electronic devices 12a˜12e in the cabinet 10, engineers can design a network platform 2, which could be the form of a web page or an application. In practice, the barcode pattern 14 is used to indicate a monitoring website address and a plurality of display parameters. The monitoring website address described in this embodiment refers to a network address of the network platform 2, while the display parameters described in this embodiment may comprise some or all information from the display position table. In other words, the display parameters can at least represent the physical position order or the wiring order of each electronic device in the cabinet 10, the model of each electronic device, the network address of each electronic device, or other relevant information. This embodiment does not limit the number of display parameters, and the display parameters may have different contents. For example, some display parameters can be used to indicate the physical position order or the wiring order of the electronic devices, some display parameters can indicate the models of the electronic devices, and some display parameters can indicate the network addresses of the electronic devices.

For the convenience of engineers, the network platform 2 can comprise a browsing interface 20, which can be used to display a plurality of device patterns 22a˜22e. In practice, the browsing interface can obtain the network addresses of each electronic device from the display parameters to connect to each electronic device. In an example, each electronic device can store its own device pattern, the electronic device 12a, for instance, stores its corresponding device pattern 22a. Subsequently, the browsing interface can connect to the electronic devices 12a˜12e individually to obtain the corresponding device patterns 22a˜22e for all the electronic devices 12a˜12e. Since the display parameters can indicate the physical position order or the wiring order of the electronic devices 12a˜12e, the browsing interface 20 can determine an arrangement order and relative positions of the device patterns 22a˜22e, shown on the screen, based on the display parameters. Specifically, some display parameters can record a network address IP1 corresponding to the electronic device 12a, and the display position 24a, along with the network address IP1, in the browsing interface 20 can be marked. Similarly, some display parameters can sequentially record the network addresses IP2˜IP5 corresponding to the electronic devices 12b˜12e, and the network addresses IP2˜IP5 relate to the display positions 24b˜24e in the browsing interface 20. Additionally, the display parameters may also indicate the model of each electronic device and the corresponding device patterns. After obtaining device patterns 22a˜22e, the browsing interface 20 can use the display parameters to verify the correctness of each device pattern. In an example, the device patterns 22a˜22e can be 2D images or 3D models representing the appearances of the electronic devices 12a˜12e. It is worth mentioning that the device patterns 22a˜22e may also be stored in network platform 2. For instance, network platform 2 may decide which device patterns to use and at which positions in the browsing interface 20 based on the received display parameters.

In this embodiment, the electronic devices 12a˜12e are demonstrated to be capable of storing their own device patterns 22a˜22e. One of the advantages is that, in practice, there are numerous models of the electronic devices, and each storing its own device pattern can save storage space of the network platform 2. This eliminates the need for the network platform 2 to pre-store a large number of device patterns corresponding to various models. For example, the electronic device 12a can store its device pattern 22a when it leaves the factory. On one hand, this ensures that device pattern 22a matches the appearance of the electronic device 12a. On the other hand, because the electronic device 12a only needs to store a single (its own) device pattern 22a, it has minimal storage space requirements and does not affect other functions of the electronic device 12a. In an example, the device pattern 22a can be a realistic appearance of the electronic device 12a, completely simulating its physical shape. This means that when the network platform 2 connects to the electronic device 12a, the network platform 2 obtains the device pattern 22a from the electronic device 12a, and the network platform 2 displays the device pattern 22a on the browsing interface 20. The device pattern 22a displayed on the browsing interface 20 can accurately correspond to the realistic appearance of the electronic device 12a, significantly reducing confusion and misjudgment during control.

In practice, when engineers need to perform remote operations, they only need to see the cabinet 10 once. Using a mobile device (such as a smartphone) which can scan the barcode pattern 14 on the electronic device 12c (the master electronic device), thereby obtaining all relevant information for connectable electronic devices 12a˜12e in one go. Additionally, when scanning the barcode pattern 14 with the mobile device, the instructions embedded within the barcode pattern 14 can automatically trigger the mobile device to open its default browser or the corresponding application, thus connecting to the network platform 2 via the monitoring website address provided by the barcode pattern 14. In an example, once the engineer successfully scans the barcode pattern 14, the browsing interface 20 of the network platform 2 will automatically display the device patterns 22a˜22e. The engineer only needs to click on one of the device patterns to connect to the corresponding electronic device. This means that when the engineer needs to switch to operate a different electronic device, they no longer need to go to the place/room where installed the cabinet 10 again. Instead, they can simply click on the device pattern corresponding to the desired electronic device on the browsing interface 20.

In addition, the browsing interface 20 can not only display the device patterns 22a˜22e but also potentially show status information of these patterns respectively. For instance, the network platform 2 can instantly retrieve a status information of the electronic device 12a. If the electronic device 12a is a power supply unit, the network platform 2 can obtain information such as voltage, current, and power being output (or to be output) by the electronic device 12a, and link the acquired status information to the device pattern 22a. Of course, there are various means by which the network platform 2 can link the status information to the corresponding device pattern 22a, without limitation in this exemplary implementation. For instance, when the engineer wishes to view the status information of the electronic device 12a in the browsing interface 20, the network platform 2 can directly display its status information around the device pattern 22a, allowing the engineer to understand the status information of the device pattern 22a and recognize that the status information is sourced from the electronic device 12a. Furthermore, the network platform 2 may choose not to display the status information directly in the browsing interface 20, instead, when the engineer clicks on the device pattern 22a to indicate interest in viewing the status information of electronic device 12a, the network platform 2 can use a pop-up dialogue box or window to display the status information. Additionally, if the network platform 2 is a web-based application (such as a web browser), when the engineer clicks on the device pattern 22a to view the status information of the electronic device 12a, the network platform 2 can choose to open a new tab to display the status information.

Please refer to FIGS. 1 to 3, FIG. 3 illustrates a schematic diagram of the electronic device monitoring method applied in a browsing interface according to another embodiment of the present invention. As shown in the figures, similar to the previous embodiment, a network platform 3 can also have a browsing interface 30, which can display a plurality of device patterns 32a˜32e. The device patterns 32a˜32e can also correspond to a plurality of electronic devices 12a˜12e. Unlike the previous embodiment, the browsing interface 30 may further comprise additional information. For example, the browsing interface 30 can have a control panel icon 34, input icon 36, and button icon 38 corresponding to each device pattern. In an example, if the device patterns 32a˜32e are the same model, then the corresponding control panel icon 34 should also be the same. For the control panel icon 34 corresponding to the device pattern 32a, it may have a status information block 340 and an input block 342. Here, the status information block 340 can display the status information of the electronic device 12a, and the input block 342 can provide the engineer with an intuitive input mean for operation commands. For instance, when the electronic device 12a is a power supply unit, the status information block 340 can display the voltage and current currently supplied by the electronic device 12a, and the engineer can input an operation command via the input block 342, which can be used to set the voltage or current output by the electronic device 12a corresponding to the device pattern 32a.

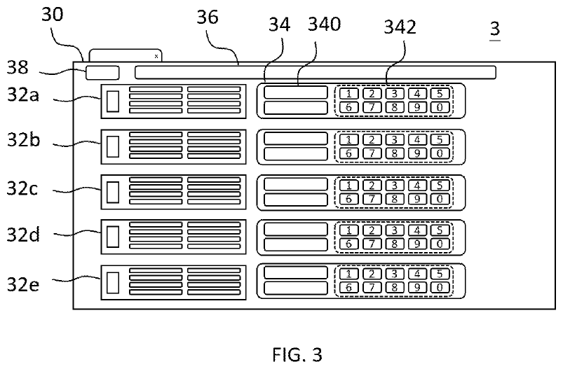

Of course, although the input block 342 depicted in FIG. 3 has numeric keys, this embodiment does not impose limitations. As long as the engineer can give operation commands from the input block 342 to control the corresponding electronic device 12a, it should fall within the scope of this embodiment. Additionally, the input icon 36 in the browsing interface 30 can accept other types of commands. For example, the engineer can use the input block 342 to set the voltage or current output by the electronic device 12a and give logic commands such as “loop” or “delay” by the input icon 36, that the engineer can precisely control the electronic device 12a. Furthermore, the engineer may directly set the voltage or current output by the electronic device 12a and add logic commands using the input icon 36. This embodiment does not limit the usage of the input icon 36.

In one example, the button icon 38 could be a select-all button, allowing, for instance, marking all device patterns 32a˜32e, or deselecting all device patterns 32a˜32e. Using the above example, suppose the engineer wishes for the electronic devices 12a˜12e to perform the same operation. In that case, the engineer can input operation commands by the input icon 36 or the input block 342 corresponding to the device pattern 32a and then click on the button pattern 38 to select all device patterns 32a˜32e. This way, the operation commands given through the input icon 36 or input block 342 can be applied to all device patterns 32a˜32e. In other words, by clicking the button icon 38, the engineer can synchronously control all electronic devices 12a˜12e, avoiding the inconvenience of inputting operation commands one by one. It is worth mentioning that the control panel icon 34 may also be part of the device pattern 32a. For example, if the electronic device 12a has a control panel, the device pattern 32a should also have the control panel icon 34 since the device pattern 32a is the realistic appearance of the electronic device 12a.

In one example, the status information of the electronic device 12a can also include an alarm information, which can, for instance, alert about overheating, abnormal output, or various other faults. In practice, when the electronic device 12a experiences a malfunction, the network platform 3 can play an alarm sound corresponding to the alarm information on the browsing interface 30. When electronic device 12a overheats, the browsing interface 30 can play a voice saying “Electronic device 12a is overheating” or it can play corresponding audio cues to indicate the type of malfunction. Of course, this embodiment does not limit the alarm information to be only in one language. In one example, the network platform 3 can also selectively play voices in various languages based on the country or custom language settings (such as Chinese, English, Japanese, etc.) set in the browsing interface 30.

It is worth mentioning that in this embodiment, the device pattern 32a may be updated periodically. For example, after maintenance or hardware upgrades of the electronic device 12a, the device pattern 32a can be updated to reflect the latest appearance of the electronic device 12a. Alternatively, the device pattern 32a can reflect the current appearance of the electronic device 12a in real-time. For instance, when electronic device 12a experiences a malfunction, a physical indicator (a LED) of the electronic device 12a may illuminate. Since the network platform 3 can receive the alarm information, the network platform 3 can proactively update the device pattern 32a, shown in the browsing interface 30, displaying the corresponding indicator (LED). In other words, the network platform 3 can simulate the real-time appearance of the electronic device 12a with the device pattern 32a, allowing the engineer to observe the device pattern 32a shown in the browsing interface 30 just like the appearance of the electronic device 12a on-site.

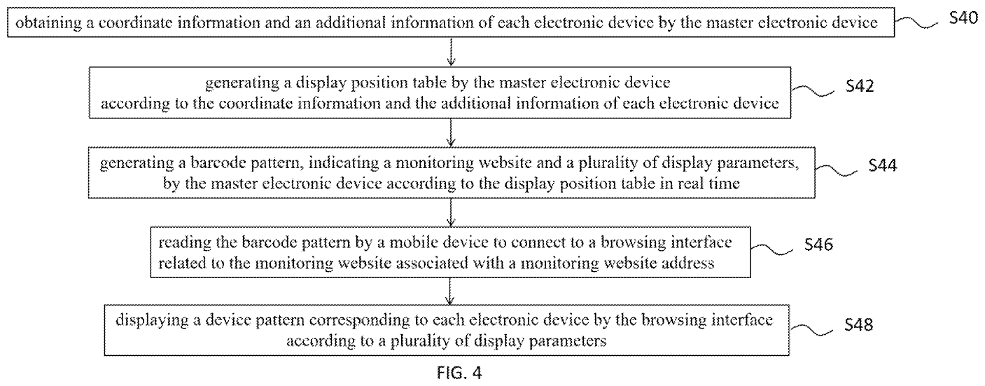

To facilitate the explanation of the electronic device monitoring method of the present invention, please also refer to FIGS. 1, 2, and 4. FIG. 4 shows a flowchart of the electronic device monitoring method according to an embodiment of the present invention. As shown in figures, the electronic device monitoring method of the present invention is used to monitor the electronic devices 12a˜12e in the cabinet 10. The electronic devices 12a˜12e comprises a master electronic device (such as the aforementioned electronic device 12c) and at least one slave electronic device (such as the aforementioned electronic devices 12a˜12b, 12d˜12e). In step S40, obtaining a coordinate information and an additional information of each electronic device by the master electronic device. In step S42, generating a display position table by the master electronic device according to the coordinate information and the additional information of each electronic device. In step S44, generating a barcode pattern, indicating a monitoring website and a plurality of display parameters, by the master electronic device according to the display position table in real time. In step S46, reading the barcode pattern by a mobile device to connect to a browsing interface related to the monitoring website associated with a monitoring website address. Finally, in step S48, displaying a device pattern corresponding to each electronic device by the browsing interface according to a plurality of display parameters. The steps of this embodiment regarding the electronic device monitoring method can be found in the aforementioned embodiments and are not further described here.

In summary, the electronic device monitoring method provided by the present invention allows the master electronic device to establish a display position table and convert it into a barcode pattern. Engineers can conveniently obtain relevant information of all connectable electronic devices at once by scanning the barcode pattern. Additionally, the electronic device monitoring method provided by the present invention can simultaneously display multiple device patterns associated with multiple electronic devices in one browsing interface. Since each device pattern mimics the appearance of the electronic device and the relative positions of the device patterns in the browsing interface correspond to the positions of the electronic devices in reality, engineers can intuitively operate and use them in the browsing interface.

What is claimed is:

1. An electronic device monitoring method for monitoring a plurality of electronic devices, defined with a master electronic device and at least one slave electronic device, installed in a cabinet, the electronic device monitoring method comprising:
obtaining a coordinate information and an additional information of each electronic device by the master electronic device;
generating a display position table by the master electronic device according to the coordinate information and the additional information of each electronic device;
generating a barcode pattern, indicating a monitoring website and a plurality of display parameters, by the master electronic device according to the display position table in real time;
reading the barcode pattern by a mobile device to connect to a browsing interface related to the monitoring website associated with a monitoring website address; and
displaying a device pattern corresponding to each electronic device by the browsing interface according to a plurality of display parameters;
wherein the barcode pattern indicates the monitoring website address and the plurality of display parameters.

2. The electronic device monitoring method according to claim 1, wherein the coordinate information of each electronic device records either a physical position order of each electronic device in the cabinet or a wiring order of each electronic device in the cabinet.

3. The electronic device monitoring method according to claim 2, wherein the additional information of each electronic device records a network address of each electronic device.

4. The electronic device monitoring method according to claim 3, wherein the browsing interface connects to each electronic device based on the network address of each electronic device to obtain a plurality of device patterns corresponding to the electronic devices.

5. The electronic device monitoring method according to claim 4, wherein the device pattern of each electronic device is displayed in the browsing interface in an arrangement order corresponding to the physical position order or the wiring order.

6. The electronic device monitoring method according to claim 1, wherein in the step of obtaining the coordinate information and the additional information of each electronic device by the master electronic device, comprising:
broadcasting a positioning request by the master electronic device; and
feedbacking, by each slave electronic device, the coordinate information and the additional information to the master electronic device based on the positioning request.

7. The electronic device monitoring method according to claim 1, wherein each device pattern displayed in the browsing interface is linked to a network address corresponding to the electronic device associated with the device pattern.

8. The electronic device monitoring method according to claim 7, further comprising:
when selecting one of the device patterns in the browsing interface, remotely connecting to the electronic device corresponding to the device pattern.

9. The electronic device monitoring method according to claim 8, wherein in the step of remotely connecting to the electronic device corresponding to the device pattern, comprising:
obtaining a status information of the electronic device corresponding to the device pattern; and
displaying the status information in the browsing interface.

10. The electronic device monitoring method according to claim 8, wherein the browsing interface further receives an operation command to control the electronic device corresponding to the selected device pattern.
